(19) United States
(12) Patent Application Publication
(10) Pub. No.: US 2004/0093357 A1
(43) Pub. Date: May 13, 2004

(54) Method for parameterizing an apparatus

(75) Inventors: Dieter Eckardt, Herzogenaurach (DE); Carsten Rebbereh, Kersbach (DE)

Correspondence Address: HENRY M FEIEREISEN, LLC, 350 FIFTH AVENUE, SUITE 4714, NEW YORK, NY, 10118, US

(73) Assignee: SIEMENS AKTIENGESELLSCHAFT, Munchen (DE)

(21) Appl. No.: 10/685,671

(22) Filed: Oct. 15, 2003

(30) Foreign Application Priority Data
Nov. 8, 2002 (DE) 102 52 109.3

(51) Int. Cl. G06F 12/00

(52) U.S. Cl. 707/200

(57) ABSTRACT

A method for parameterizing an apparatus is described. An dataset with a parameter is inputted and transmitted to the apparatus and acknowledged upon receipt. The identity of the acknowledged dataset is checked by comparison with the inputted dataset, and the received dataset is released if the two datasets agree. The proposed parameterization method can be used to read in parameters, in particular safety-related parameters, at a predetermined memory location of the apparatus without introducing changes or errors.

### CROSS-REFERENCES TO RELATED APPLICATIONS

This application claims the priority of German Patent Application, Serial No. 102 52 109.3, filed Nov. 8, 2002, pursuant to 35 U.S.C. 119(a)-(d), the disclosure of which is incorporated herein by reference.

### BACKGROUND OF THE INVENTION

The present invention relates to a method for parameterizing an apparatus with a data input device that is connected with the apparatus via a datalink.

Parameterization and startup tools are commercially available. These tools can be used to parameterize, for example, controllers or drive systems by using a data input device, for example a personal computer (PC), in particular a portable PC, or another type of programming device (PD). During parameterization, a large quantity of parameters which include at least one parameter identifier and a parameter value, have to be entered into the apparatus to be parameterized. The commercially available parameterization and startup tools typically include a PC user interface to facilitate parameterization. This user interface simplifies an initial startup and/or and functional parameterization because the user only has to click through the various parameter masks.

The datalink between the PC, or PD, and the apparatus to be parameterized can be either a dedicated point-to-point connection (for serial or parallel data transmission) or a Fieldbus. For example, a converter can be connected for data transmission with the PC/PD via the point-to-point connection. After parameterization, the datalink is removed from the converter and connected to another converter of the drive system. When using a Fieldbus, several converters of a drive system connected to the Fieldbus can be sequentially parameterized without having to set up a hardware data transmission link for each connection.

When parameterizing with a PC or PD, this process is critical since, on one hand, the PC or PD does not represent a secure platform and, on the other hand, the transmission path to the apparatus may potentially introduce errors. In parameterization it is assumed that the datasets of individual parameters were correctly received by the apparatus to be parameterized. Significant material damage and even injury to personnel can occur if an error occurs and the parameterization involves safety-related functions. Parameterization also includes a change of already stored parameters.

It would therefore be desirable and advantageous to provide an improved method for parameterizing an apparatus, which obviates prior art shortcomings and is able to specifically prevent errors during data transmission and storage.

### SUMMARY OF THE INVENTION

According to one aspect of the present invention, a method for parameterizing an apparatus, includes the steps of inputting a dataset having at least one parameter with a data input device that is connected with the apparatus via a datalink, the dataset including at least one parameter number and a parameter value; transmitting the inputted dataset to the apparatus; acknowledging receipt of the transmitted dataset; checking that the acknowledged dataset is identical to the inputted dataset; and releasing the received dataset if the acknowledged dataset is identical to the inputted dataset.

An apparatus to be parameterized acknowledges each received dataset of a parameter and uses the transmitted parameter to thereafter check the identity of the received dataset. It can thereby be checked if the apparatus to be parameterized has received error-free the dataset of a parameter entered into the data input device. The parameter received in the apparatus is released only after its identity has been confirmed. Since each dataset of a received parameter is acknowledged with this method of the invention, the functionality of the datalink can be monitored and verified. If an identity is not confirmed, then the dataset of a transmitted parameter must have been changed during transmission over the datalink, so that the received a dataset for the apparatus cannot be released.

Within the apparatus to be parameterized, each dataset of a received parameter is processed and a parameter value of the received parameter is finally stored at a specified address in a memory. However, this additional processing of the dataset of the received parameter can also have errors which can lead to the same problems as described above.

According to an advantageous embodiment of the invention, each dataset of a received parameter is decomposed into its separate data components, for example parameter number, parameter value, . . . , and separately stored. An associated memory address for the parameter value is determined based on the stored parameter number, and the parameter value is stored at this memory address in memory. The dataset of the received parameter is acknowledged by assembling this dataset from its stored parameter number and a stored parameter value, wherein the associated memory address is again determined from the stored parameter number. If the identity is confirmed by the identity check, then the transmission path between the data input device and the input of the parameters into the memory of the apparatus to be parameterized is error-free. In other words, the datasets of parameters to be transmitted were inputted into the data input device in the same form as they were read in the memory of the apparatus to be parameterized.

According to another advantageous feature, a bit pattern of each dataset of received parameters is inverted, and then inverted again for the identity check. This double-inversion restores the original data so that systematic errors on the transmission link can be identified.

The check that the acknowledged dataset is identical to the inputted dataset can be performed either visually or automatically, for example, by a machine.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is an illustration of a conventional arrangement for parameterizing a device; and

FIG. 2 is a schematic of an advantageous method according to the invention.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

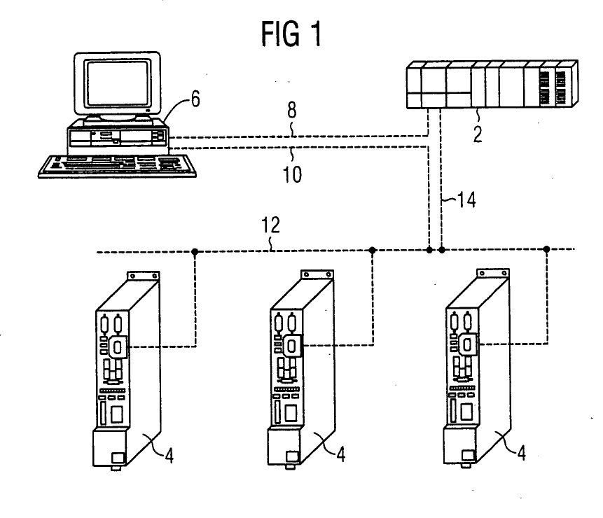

Turning now to the drawing, and in particular to FIG. 1, there is shown a conventional arrangement for parameterizing an apparatus 2 or several apparatuses 4. A data input device 6 is provided for inputting parameters. The data input device 6 which can be a personal computer (PC) or a programming device (PD), is connected for data transmission via a first datalink 8 with an apparatus 2 and/or with a second datalink 10 with an apparatus 4. The apparatus 2 in this diagram can be an automation system and the apparatus 4 can be one or more inverters of a decentralized drive system. The inverters 4 can be connected with each other for data transmission by a Fieldbus 12. The automation system 2 can also be connected by another bus 14 with the Fieldbus 12. The first datalink 8 that connects the data input device 6 with the automation system 2, can be a serial point-to-point connection. Conversely, the second datalink 10 that connects the data input device 6 with the inverter(s) 4 can be implemented as several parallel connections and/or as a bus. The two datalinks 8 and 10 can also be connected with the data input device 6, since the first exemplary datalink 8 includes a serial interface and the second datalink 10 a parallel interface.

During parameterization, an operator sequentially enters the datasets of several parameters, which are then transmitted serially or parallel to the apparatus 2 or the apparatuses 4.

In the apparatuses 2 and 4, datasets of received parameters are initially stored in a receive buffer 16 before being stored in a data memory 18. The data memory 18 can also be referred to as parameter memory. A device 20 which can also be referred to as parameter manager is used to read out a dataset which includes at least a parameter number and a parameter value. The parameter manager 20 can be implemented, for example, by a microprocessor and/or a signal processor which can be used, in addition to reading parameter data, also for controlling the apparatuses 2 and 4, respectively.

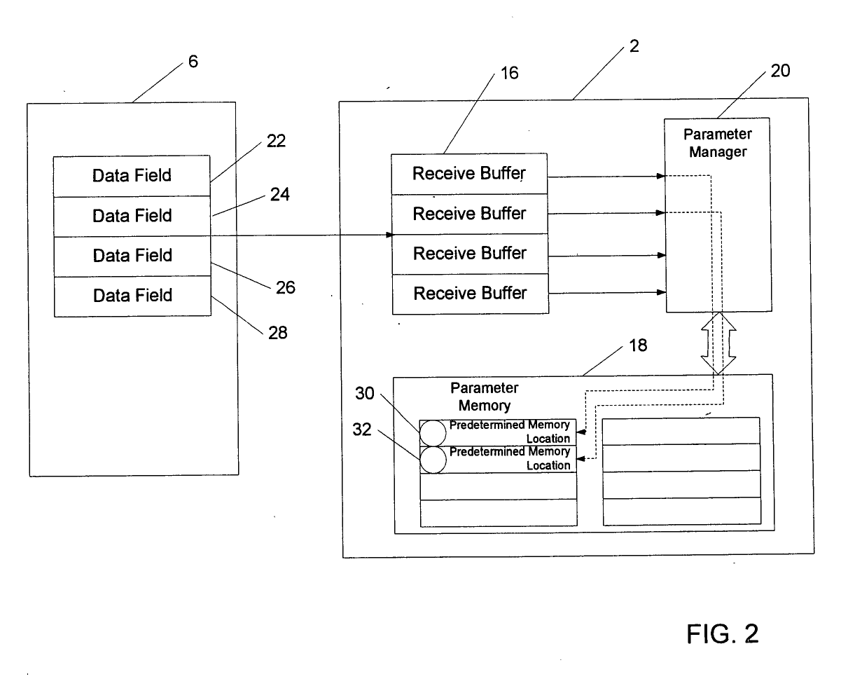

In addition to the aforementioned data, i.e., the parameter number and parameter value, the dataset can also include a parameter index. A parameter index is included when a parameter has different parameter values for different applications. If a parameter does not have different parameter values, then the parameter index is ignored. As shown in FIG. 2, these data of a dataset for a parameter are each inputted in a corresponding data field 22, 24, 26 and 28 of the data input device 6. For example, the parameter number can be stored in data field 22 and parameter index in data field 24. The parameter value which can be, for example, is 32-bit word, can be subdivided into two fields, whereby 16 bits can be stored, for example, in corresponding data fields 26 and 28. These data fields 26 and 28 can be read and transmitted serially or in parallel. On the receive side of the apparatuses 2 and 4, respectively, the receive buffer 16 has then also several data fields into which the data are read serially or in parallel. The parameter manager 20 determines from the parameter number, or from the parameter number and the parameter index, a memory address where the parameter value is to be stored in the parameter memory 18.

In a conventional parameterization process, the operator of the data input device does not know if the apparatuses 2 and 4, respectively, did receive the inputted data. An inputted value may also not have been stored inside the data input device 6 exactly in the assigned data fields for data transmission. Accordingly, conventional methods for parameterization cannot reliably indicate if the provided parameter values have actually been read into the parameter memory 18 of the apparatuses 2 and 4, respectively. Possible errors can therefore only be recognized based on the operation of the apparatuses 2 and 4, respectively.

When integrating safety-related the functions in the apparatuses 2 and/or 4, which typically require a number of parameters for suitably defining the corresponding functions, any error can cause more than just material damage.

The method of the invention can also eliminate such safety-related parameterization errors. This is achieved by including additional steps in the parameterization process. An additional method step is, for example, the acknowledgment of receipt of each individual dataset of received parameters in the apparatuses 2 and/or 4. In other words, the data stored in the data field of the receive buffer 16 are retransmitted via the datalink 8 and/or 10 to the data input device 6. An identity check is performed in an additional method step. In this identity check, the data in the individual data fields of the transmitted dataset are compared with the data in the individual data fields of the acknowledged received dataset. If these data agree, then the identity check has a positive result and the identity is confirmed. The result is transmitted to the apparatuses 2 and/or 4, and the received dataset stored in the receive buffer 16 is released. In this way, any errors that occurred during transmission can be identified. However, the additional method step is unable to identify errors that occur when parameter values are read into a parameter memory 18.

These errors can be identified according to another advantageous embodiment of the method of the invention by including additional methods steps, whereby not only the received dataset is acknowledged, but also the read-in parameter value. The memory address is hereby determined from the parameter number, or from the parameter number and parameter index, which are stored at pre-defined locations 30 or 32 in the parameter memory 18, and the parameter value stored therein is read out. The parameter number, the read-out parameter value and the parameter index again form a dataset which is acknowledged upon receipt. In the identity check, this received acknowledged combined dataset is compared with the inputted dataset. If the identity is confirmed, the read-in parameter value is released. Accordingly, this advantageous embodiment of the method checks the parameterization between the data input device and a read-in parameter value.

Systematic errors that may occur on the transmission path can be identified by inverting a bit pattern of each dataset of a received parameter for acknowledging the correct receipt. This acknowledged inverted bit pattern is then once more inverted for the identity check, thereby canceling the inversion. Without this inversion, systematic errors could remain undetected.

The method of the invention for parameterizing an apparatus 2 and/or 4 ensures that inputted datasets of parameters to be transmitted, in particular safety-related parameters, are read in unchanged, in particular in the intended memory locations in the apparatuses 2 and 4, respectively.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and their equivalents:

What is claimed is:

1. A method for parameterizing an apparatus, comprising the steps of:
inputting a dataset having at least one parameter with a data input device that is connected with the apparatus via a datalink, the dataset including at least one parameter number and a parameter value;
transmitting the inputted dataset to the apparatus;
acknowledging receipt of the transmitted dataset;
checking that the acknowledged dataset is identical to the inputted dataset; and
releasing the received dataset if the acknowledged dataset is identical to the inputted dataset.

2. The method of claim 1, and further comprising the steps of decomposing each received dataset into the parameter number and the parameter value; separately storing the parameter number and the parameter value at a memory address determined from the parameter number; and combining the dataset of a received parameter to be acknowledged from its stored parameter number and the parameter value stored at the determined memory address.

3. The method of claim 1, wherein acknowledging receipt includes inverting a bit pattern of a received dataset, and checking that the acknowledged dataset is identical to the inputted dataset includes inverting the inverted bit pattern again.

4. The method of claim 1, wherein checking that the acknowledged dataset is identical to the inputted dataset includes a visual check.

5. The method of claim 1, wherein checking that the acknowledged dataset is identical to the inputted dataset includes an automatic check.
